(19) United States
(12) Patent Application Publication
(10) Pub. No.: US 2019/0278927 A1
(43) Pub. Date: Sep. 12, 2019

(54) ELECTRONIC DOCUMENT DISPLAY CONTROL SYSTEM

(71) Applicant: FUJI XEROX CO., LTD., Tokyo (JP)

(72) Inventor: Yasuaki KONISHI, Kanagawa (JP)

(73) Assignee: FUJI XEROX CO., LTD., Tokyo (JP)

(21) Appl. No.: 16/141,991

(22) Filed: Sep. 26, 2018

(30) Foreign Application Priority Data
Mar. 8, 2018 (JP) 2018-041609

(51) Int. Cl. G06F 21/62; G06K 9/00; G06K 9/62; G06F 3/14; G06F 21/32

(52) U.S. Cl. CPC G06F 21/6209; G06K 9/00288; G06T 7/73; G06F 3/14; G06F 21/32; G06K 9/6201

(57) ABSTRACT

An electronic document display control system includes an obtaining unit that, when a restricted electronic document, which is available only to authorized persons when displayed, is displayed on a display device, obtains unauthorized person presence information, which indicates that an unauthorized person might view the restricted electronic document and a display control unit that, when the obtaining unit obtains the unauthorized person presence information, prevents the restricted electronic document from being displayed.

### CROSS-REFERENCE TO RELATED APPLICATIONS

This application is based on and claims priority under 35 USC 119 from Japanese Patent Application No. 2018-041609 filed Mar. 8, 2018.

### BACKGROUND

### (i) Technical Field

The present disclosure relates to an electronic document display control system.

### (ii) Related Art

Japanese Unexamined Patent Application Publication No. 2007-72778, for example, discloses an electronic meeting server that receives authentication information regarding a person from an electronic meeting client, authenticates the person on the basis of registered authentication information and the received authentication regarding the person, and transmits information for inhibiting a process for displaying data performed by the electronic meeting client in accordance with a result of the authentication.

### SUMMARY

If a restricted electronic document available only to authorized persons is displayed without condition and persons who can view the displayed electronic document include unauthorized persons, the value of the restriction upon access to the electronic document is diminished.

Aspects of non-limiting embodiments of the present disclosure relate to suppression of diminishment of the value of restriction upon access to electronic documents.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electronic document display control system including an obtaining unit that, when a restricted electronic document, which is available only to authorized persons when displayed, is displayed on a display device, obtains unauthorized person presence information, which indicates that an unauthorized person might view the restricted electronic document and a display control unit that, when the obtaining unit obtains the unauthorized person presence information, prevents the restricted electronic document from being displayed.

### BRIEF DESCRIPTION OF THE DRAWINGS

An exemplary embodiment of the present disclosure will be described in detail based on the following figures, wherein:

FIG. 1 is a diagram illustrating an outline of an electronic document display control system according to an exemplary embodiment;

FIG. 2 is a block diagram illustrating the configuration of the electronic document display control system;

FIG. 3 is a flowchart illustrating an example of a process performed by the electronic document display control system; and

FIGS. 4A and 4B are diagrams illustrating examples of a screen displayed on a display device in S110 illustrated in FIG. 3.

### DETAILED DESCRIPTION

An exemplary embodiment of the present disclosure will be described in detail hereinafter with reference to the accompanying drawings.

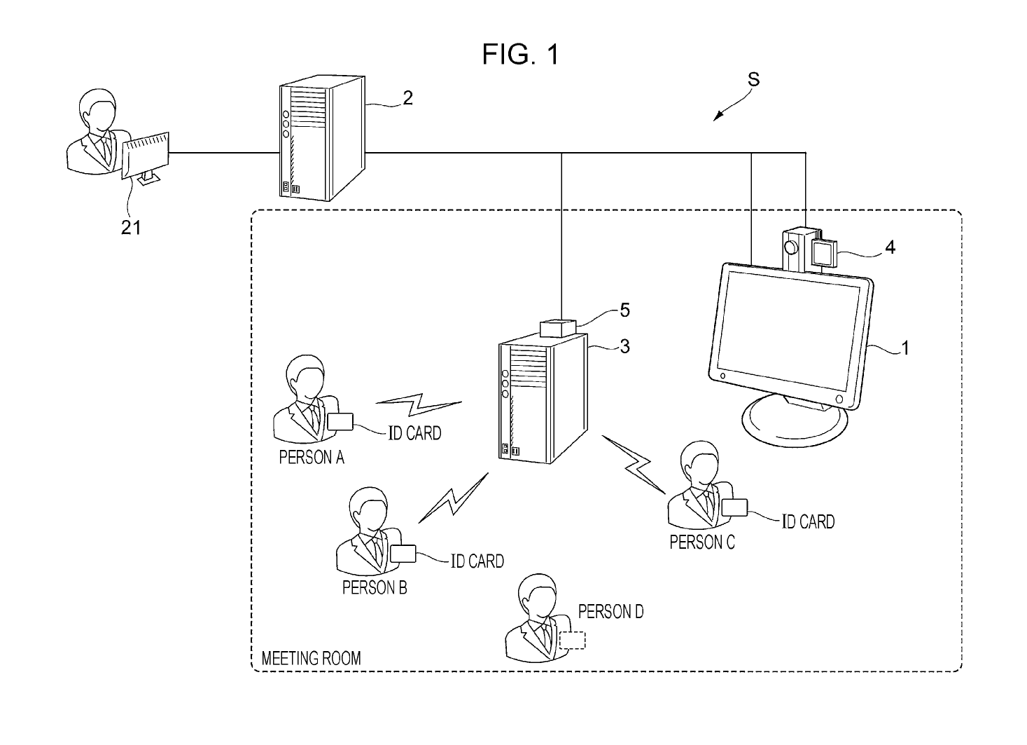

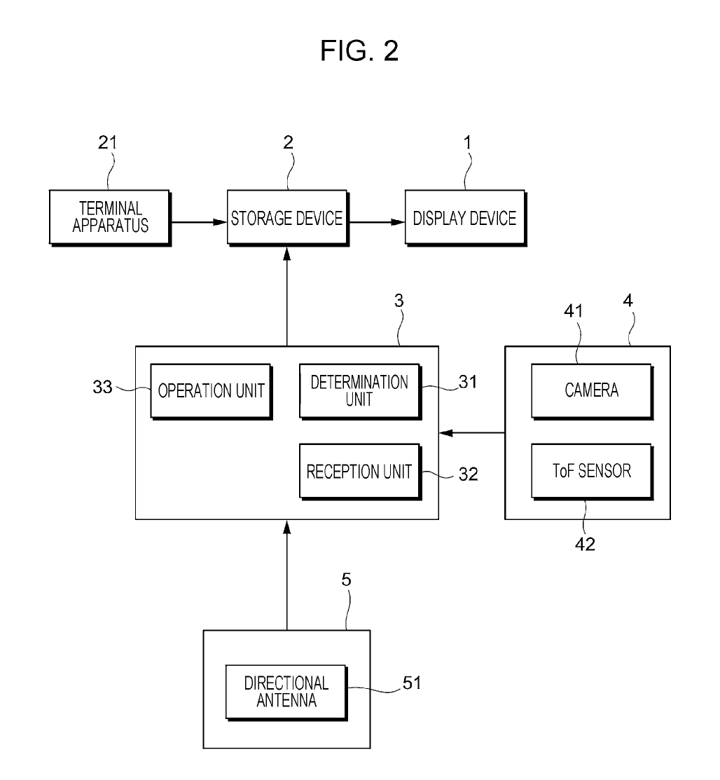

FIG. 1 is a diagram illustrating an outline of an electronic document display control system S according to the present exemplary embodiment. FIG. 2 is a block diagram illustrating the configuration of the electronic document display control system S.

The electronic document display control system S illustrated in FIG. 1 includes a display device 1 provided in a meeting room, such as a display, a storage device 2 storing electronic documents, such as a person computer (PC), a control terminal 3, such as a PC, that displays the electronic documents on the display device 1 a detection device 4 that detects the number of persons in the meeting room and positions of the persons, and a detection device 5 that detects identification (ID) information and positional information regarding the persons in the meeting room.

Electronic documents may be stored in the storage device 2 through a terminal apparatus 21. Restricted electronic documents, which are available only to authorized persons when displayed on the display device 1 and will be described later, too, may be set through the terminal apparatus 21. The terminal apparatus 21 may be included in the electronic document display control system S.

The detection device 4 is attached to the display device 1 in the present exemplary embodiment. As illustrated in FIG. 2, the detection device 4 includes, for example, a camera 41 that captures an image of the meeting room and a time-of-flight (ToF) sensor 42 that measures a distance to an object on the basis of time taken by light from a light source to be reflected by the object and return. The detection device 4 detects the number of persons by processing an image captured by the camera 41. The detection device 4 measures positions of the persons relative thereto using the ToF sensor 42 to detect the positions of the persons in the meeting room. Information regarding the number of persons and the positions of the persons is transmitted to the control terminal 3.

The detection device 5 is attached to the control terminal 3 in the present exemplary embodiment. The detection device 5 includes a rotatable directional antenna 51 and records ID information, which is an example of identification information for authentication, transmitted from ID cards carried by persons as radio waves and the intensity of the radio waves by rotating the directional antenna 51. The angle of the directional antenna 51 when the intensity of the radio waves is highest may be recorded instead of the intensity of the radio waves. Alternatively, a plurality of directional antennas 51 whose angles are different from one another may be installed instead of rotating a single directional antenna 51. By detecting the positions of the ID cards relative to the directional antenna 51, not only ID information but also information regarding the positions of the persons who carry the ID cards are obtained. The ID information and the positional information are transmitted to the control terminal 3.

Although the ID cards carried by the persons may employ passive radio-frequency identification (RFID), which passively emits radio waves, or active RFID, which actively emits radio waves, or may have a near-field communication function such as Bluetooth (registered trademark). The detection device 5 is configured to have any of these functions. In the case of passive RFID, the directional antenna 51 outputs an ID request signal to the ID cards and receives identifiers (IDs) transmitted in response to the ID request signal to obtain ID information. By measuring the intensity of radio waves, the positions of the persons who carry the ID cards are detected on the basis of the ID information and angles and distances relative to the directional antenna 51.

In addition, some persons might carry ID cards and other persons might not carry ID cards. The persons who carry ID cards are detected not only by the detection device 4 but also by the detection device 5. The persons who do not carry ID cards are detected by the detection device 4 but not detected by the detection device 5. Whether there are persons who do not carry an ID card, therefore, can be determined on the basis of results of detection performed by the detection device 4 and results of detection performed by the detection device 5, and, if any, the number of persons who do not carry an ID card can be detected.

The electronic document display control system S illustrated in FIG. 1 is used when a meeting is held in the meeting room where the display device 1 is installed. That is, a plurality of persons who have gathered in the meeting room view the display device 1 in this case. The display device 1 displays electronic documents stored in the storage device 2, and the persons view the electronic documents displayed on the display device 1.

The electronic documents displayed on the display device 1 are classified into electronic documents that are available only to authorized persons when displayed on the display device 1 (restricted electronic documents) or electronic documents that are available to anyone (unrestricted electronic documents). Persons in a meeting are classified into those who are authorized to view restricted electronic documents (authorized persons) and those who are not authorized to view restricted electronic documents (unauthorized persons). The unauthorized persons include those who carry an ID card and those who do not carry an ID card. When availability is set for each restricted electronic document to be displayed on the display device 1, for example, an authorized person might not be authorized to view every restricted electronic document to be displayed in a meeting. That is, a person might be an authorized person for some restricted electronic documents but might be an unauthorized person for other restricted electronic documents.

Restricted electronic documents available to anyone in a meeting may be displayed on the display device 1, but if restricted electronic documents available only to some persons are displayed on the display device 1, those who are not authorized to view the restricted electronic documents undesirably view the restricted electronic documents, which diminishes the value of the restriction upon access to electronic documents. If there are unauthorized persons, therefore, restricted electronic documents should not be displayed on the display device 1 without condition.

Presence of unauthorized persons for some restricted electronic documents, on the other hand, might be simply because of a lack of an authorization process, and it might be allowable to perform an authorization process for the unauthorized persons. That is, there might be persons who are practically allowed to view restricted electronic documents but have not been officially authorized to view the restricted electronic documents. If a process for giving authority to an unauthorized person may be performed during a meeting, therefore, the meeting will proceed smoothly.

In the present exemplary embodiment, a configuration for addressing such a situation is employed. Details of the configuration will be described hereinafter.

The terminal apparatus 21 performs an operation for restricting access to electronic documents. In FIG. 1, persons A to C carry an ID card, and a person D does not carry an ID card. The person D, therefore, does not have ID information and is not authorized to view any restricted electronic documents.

As illustrated in FIG. 2, the control terminal 3 includes a determination unit 31 that determines the number of persons and positions of the persons from detection information transmitted from the detection device 4 and person IDs and the positions of the persons from detection information transmitted from the detection device 5.

More specifically, the determination unit 31 extracts face images of persons from an image obtained by the camera 41 of the detection device 4 and identifies the number of persons A to D. In the present exemplary embodiment, there are four persons A to D. The determination unit 31 also calculates distances from distance information obtained by the ToF sensor 42 of the detection device 4 and detects positions of the persons A to D. Face information and positional information regarding the persons A to D are thus obtained from the detection information transmitted from the detection device 4 regardless of presence or absence of ID cards.

The determination unit 31 also detects ID information regarding the persons A to C, who carry an ID card, and the positions of the persons A to C from results of reception performed by the directional antenna 51 of the detection device 5. If the persons A to C move, the determination unit 31 can detect the movement and positions of the persons A to C after the movement from results of reception performed by the directional antenna 51. As described above, the person D does not carry an ID card, and the detection device 5 does not detect the position of the person D.

The determination unit 31 associates IDs of the persons A to C and face images of the persons A to C with each other on the basis of the obtained information. The determination unit 31 identifies the IDs, the face images, and the positions of the persons A to C, that is, identifies where a person who has a certain ID is located. The identification is achieved on the basis of the information transmitted from the detection device 4 and the detection device 5.

The determination unit 31 identifies a face image and a position of the person D from the information transmitted from the detection device 4.

The determination unit 31 makes a determination and transmits a result of the determination to an operation unit 33 when there is an instruction to display a restricted electronic document. As a result, even if some persons enter or exit the meeting room and the number of persons has changed, no problem occurs. Alternatively, the determination unit 31 may make a determination and transmit a result of the determination at a beginning of a meeting. Push notification or pull notification may be performed.

In the control terminal 3, the determination unit 31 transmits results of a determination, namely the number of persons and positions of the persons based on detection information from the detection device 4 and person IDs and positions of the persons based on detection information from the detection device 5 to the operation unit 33. If the detection information is not obtained from the detection device 4 or the detection device 5, however, the determination unit 31 transmits information indicating the event (information indicating that there has been a malfunction with respect to obtaining of unauthorized person presence information, which will be described later) to the operation unit 33.

In addition to the determination unit 31, the control terminal 3 includes a reception unit 32 for allowing an authorized person to give authority to an unauthorized person and the operation unit 33 that displays the electronic documents stored in the storage device 2 on the display device 1.

The reception unit 32 includes, as a function of performing the process for giving authority, for example, a reading section for reading information from an ID card and an input section for inputting a password. The reception unit 32 checks, on the basis of received information, that a person who is giving authority is an authorized person and that there has been an instruction to give authority. The reception unit 32 also identifies, among the persons A to C who carry an ID card, a person who has approached the control terminal 3 on the basis of a result of detection performed by the detection device 5 to identify a person who is giving authority. As a result, the process for giving authority can be completed only by inputting a password without using an ID card.

The operation unit 33 of the control terminal 3 has a function of issuing an instruction to display electronic documents to be used in a meeting on the display device 1. That is, when operated, the operation unit 33 instructs the storage device 2 to display, on the display device 1, electronic documents including restricted electronic documents. When a document ID is input to the operation unit 33, the operation unit 33 transmits the document ID to the storage device 2 and instructs the storage device 2 to display a corresponding electronic document on the display device 1 (display instruction). When the operation unit 33 is operated, predetermined electronic documents may be displayed on the display device 1 in predetermined order.

The operation unit 33 of the control terminal 3 receives, from the storage device 2, authority information preset to electronic documents for which a display instruction has been issued to the storage device 2. That is, the storage device 2 refers to authority information corresponding to electronic documents specified by the operation unit 33, transmits the authority information to the operation unit 33, and waits for a response indicating whether the electronic documents may be displayed on the display device 1. The storage device 2 may transmit authority information to the operation unit 33 of the control terminal 3 for only restricted electronic documents or for all electronic documents including unrestricted electronic documents. As described above, authority information is set to the electronic documents stored in the storage device 2 through the terminal apparatus 21.

The operation unit 33 that has received authority information regarding restricted electronic documents from the storage device 2 determines, on the basis of a result of a determination made by the determination unit 31, whether all the persons A to D are authorized to view the restricted electronic documents. If the result of the determination indicates that there is an unauthorized person among the persons A to D, the operation unit 33 identifies the unauthorized person and displays a face image of the person on the display device 1. The face image in this case may be a face image of the person obtained in advance or may be a face image obtained by capturing an image of the identified person using the camera 41 of the detection device 4.

The face image is displayed on the display device 1, and a person is asked whether to start the process for giving authority. Display of the restricted electronic documents on the display device 1 is thus temporarily stopped. If the restricted electronic documents are displayed on the display device 1 without condition, unauthorized persons might view the restricted electronic documents. By temporarily stopping the display, the value of the restriction upon access to electronic documents is not diminished. In other words, in the present exemplary embodiment, if unauthorized person presence information, which indicates that unauthorized persons might view restricted electronic documents, is obtained, restricted electronic documents are not displayed.

If the process for giving authority is performed after a face image is displayed on the display device 1, the operation unit 33 allows the storage device 2 to display the restricted electronic documents on the display device 1. As a result, the restricted electronic documents are displayed on the display device 1 in the meeting room, and the persons A to D refer to the restricted electronic document in the meeting.

If the process for giving authority is not performed, the operation unit 33 prevents the storage device 2 from displaying the restricted electronic documents on the display device 1. As a result, the restricted electronic documents are not displayed on the display device 1, and the value of the restriction upon access to electronic documents is not diminished.

If a result of a determination made by the determination unit 31 after the determination unit 31 receives authority information regarding the restricted electronic documents from the storage device 2 indicates that all the persons A to D are authorized to view the restricted electronic documents, the operation unit 33 allows the storage device 2 to display the restricted electronic documents on the display device 1.

If information indicating that information has not been obtained from the detection device 4 or the detection device 5 is output from the determination unit 31, the operation unit 33 prevents the storage device 2 from displaying the restricted electronic documents on the display device 1.

Next, a process performed by the electronic document display control system S will be described.

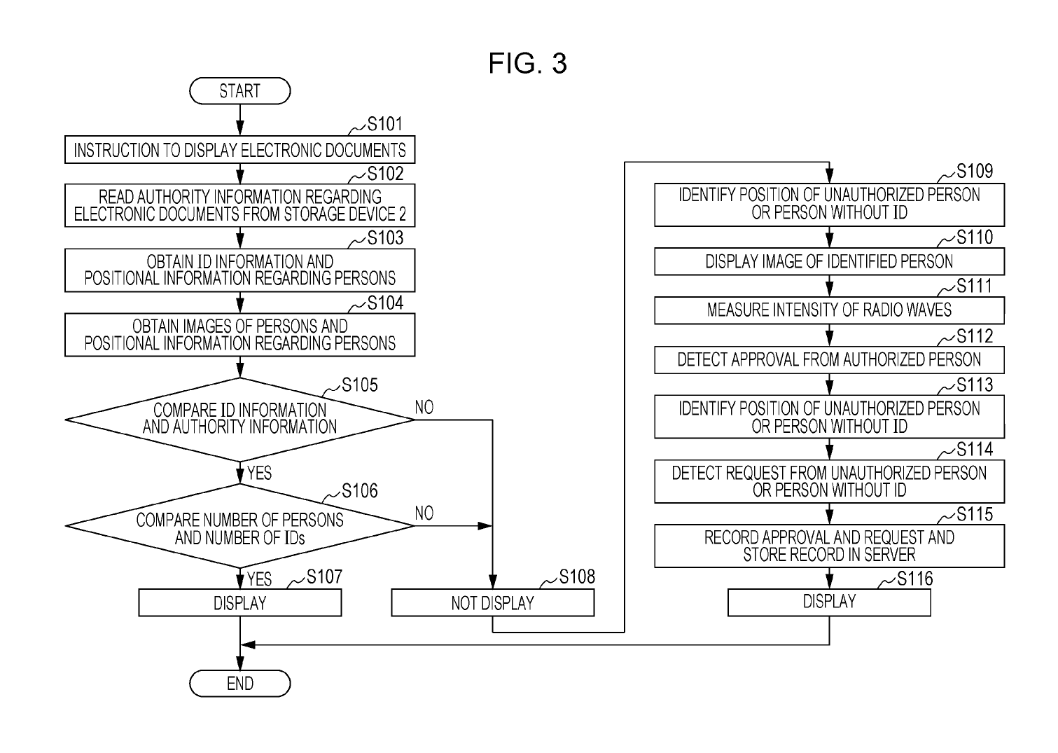

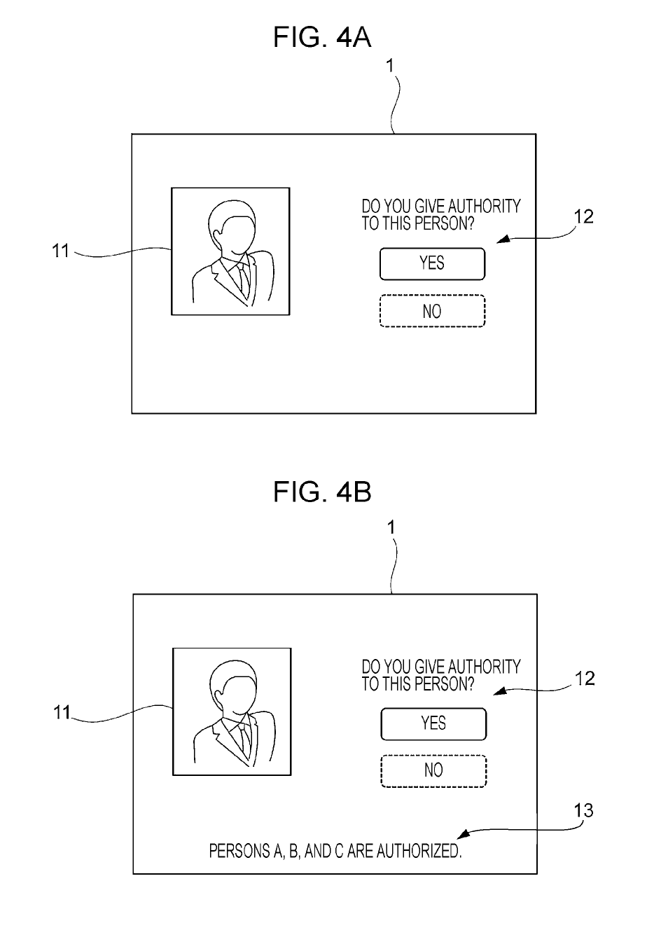

FIG. 3 is a flowchart illustrating an example of the process performed by the electronic document display control system S. FIGS. 4A and 4B are diagrams illustrating examples of a screen displayed on the display device 1 in S110 illustrated in FIG. 3.

In the example of the process illustrated in FIG. 3, if, among the persons A to D, the person C (refer to FIG. 1) instructs the control terminal 3 to display electronic documents (S101), for example, the control terminal 3 transmits document IDs of the electronic documents to be displayed to the storage device 2. In response to this, the storage device 2 transmits authority information (disclosure authority information) regarding the document IDs to the control terminal 3. That is, the control terminal 3 reads the authority information regarding the electronic documents from the storage device 2 (S102). The authority information is used to identify persons who are authorized to view the electronic documents corresponding to the document IDs or persons who are not authorized view the electronic documents and set for the document IDs in advance.

Here, the authority information regarding the document IDs is used to identify persons who are authorized to view the electronic documents. The authority information might be information that specifically indicates authorized persons or information that specifies conditions of authorized persons. In the latter case, the authorized persons may be determined using attribute data regarding persons such as posts.

The determination unit 31 of the control terminal 3 obtains ID information and positional information regarding the persons A to C from information transmitted from the detection device 5 (S103) and images of the persons A to D and positional information regarding the persons A to D from information transmitted from the detection device 4 (S104). After obtaining the ID information regarding the persons A to C, the determination unit 31 authenticates the persons A to C using identification information for authentication.

The ID information and the positional information are obtained by rotating the directional antenna 51 and recording, using the detection device 5, ID information and the intensity of radio waves transmitted from the ID cards of the persons A to C or the angle of the directional antenna 51 at a time when the intensity of radio waves is highest. Alternatively, a plurality of antennas whose angles are different from one another may be used instead of rotating the directional antenna 51. IDs of the persons A to C are stored in the ID cards of the persons A to C.

The number of persons and positional information are obtained from results of measurement performed by the camera 41 and the ToF sensor 42.

After obtaining the ID information from the ID cards of the persons A to C, the determination unit 31 authenticates the persons A to C using the identification information for authentication. The persons A to C may be authenticated by comparing face images of the persons A to C extracted from an image captured by the camera 41 and face information for authentication instead of, or in addition to, the use of the ID information stored in the ID cards. The identification information for authentication and the face information for authentication may be stored in the control terminal 3 or may be stored in another device such as the storage device 2 and obtained by the control terminal 3 from the storage device 2 as a result of issuance of a request.

The determination unit 31 processes the obtained ID information and positional information based on the information from the detection device 4 and the number of persons and positional information based on the information from the detection device 5 and associates the ID information and the positional information with each other. As a result, the persons A to C who carry an ID card and the person D who does not carry an ID card are identified. The determination unit 31 also compares the ID information regarding the persons A to C and the authority information (disclosure authority information) regarding the electronic documents obtained from the storage device 2 (S105) and determines whether there are authorized persons among the persons A to C. Although the determination unit 31 makes the determination in the present exemplary embodiment, the determination unit 31 may perform the above association and transmit information regarding the association to the operation unit 33 and the operation unit 33 may make the determination. Alternatively, the storage device 2 may make the determination instead of the control terminal 3.

The storage device 2 may transmit the authority information to the control terminal 3 regardless of whether the electronic documents are restricted electronic documents.

If there are authorized persons among the persons A to C (YES in S105), the number of persons and the number of IDs of the authorized persons are compared (S106), and whether all the persons are authorized persons is determined. If there are authorized persons among the persons A to C and the number of persons and the number of IDs of the authorized persons are the same, all the persons A to C are authorized persons. If the number of persons and the number of IDs of the authorized persons are the same (YES in S106), therefore, the determination unit 31 notifies the storage device 2 that the electronic documents to be displayed may be displayed on the display device 1 even if the electronic documents are restricted electronic documents. As a result, the display device 1 displays the electronic documents (S107).

If there are no authorized persons among the persons A to C (NO in S105), or if the number of persons and the number of IDs of the authorized persons are not the same (NO in S106), on the other hand, the determination unit 31 notifies the storage device 2 that the electronic documents to be displayed are not to be displayed on the display device 1. As a result, the display device 1 does not display the restricted electronic documents at this point (S108).

If the number of persons is larger than the number of IDs of the authorized persons (NO in S106), there are unauthorized persons among the persons. If the electronic documents are displayed on the display device 1 in this case, the value of the restriction upon access to electronic documents is diminished. If unauthorized persons might view the restricted electronic documents, therefore, the control terminal 3 prevents the restricted electronic documents from being displayed on the display device 1.

Although the number of persons A to D and the number of IDs of authorized persons are compared in the present exemplary embodiment, the process performed is not limited to this. Whether each of the persons A to D is an authorized person may be determined, and if there is at least one unauthorized person (if there is the unauthorized person D), the control terminal 3 may prevent the restricted electronic documents from being displayed on the display device 1, instead. Aside from a case where there is the unauthorized person D, if the person A is not authorized to view a certain restricted electronic document and presence of the person A, who carries an ID card but is not an authorized person, is confirmed, for example, the certain restricted electronic document is prevented from being displayed on the display device 1.

If unauthorized person presence information, which indicates that unauthorized persons might view restricted electronic documents, is obtained when the restricted electronic documents are displayed on the display device 1, the operation unit 33 of the control terminal 3 prevents the restricted electronic documents from being displayed on the display device 1. If information indicating that a person who has identification information for authentication but is not authorized to view restricted electronic documents or a person who does not have identification information might view the restricted electronic documents is obtained when the restricted electronic documents are displayed on the display device 1, the operation unit 33 of the control terminal 3 prevents the restricted electronic documents from being displayed on the display device 1. The unauthorized person presence information hereinafter does not exclude information indicating that a person who has identification information for authentication but is not authorized to view restricted electronic documents or a person who does not have the identification information might view the restricted electronic documents.

The unauthorized person presence information herein refers to information indicating that there might be unauthorized persons among persons who are going to view restricted electronic documents. The unauthorized person presence information might be information indicating that person information, which is information regarding persons who might view restricted electronic documents, and authorized person information, which is information regarding authorized persons, do not match (disagreement with the authorized person information) or information output to the operation unit 33 when at least part of information for authentication regarding persons who might view restricted electronic documents has not been obtained (a failure in obtainment).

The person information refers to information with which persons located within a certain distance from the display device 1 can be detected. In the present exemplary embodiment, the person information includes information detected by the camera 41 of the detection device 4 and related to the persons A to C who carry an ID card and the person D who does not carry an ID card, but the person information may also include the identification information for authentication information and the face information associated with the foregoing information. The authority information herein refers to information used to identify persons authorized to view restricted electronic documents and is, in the present exemplary embodiment, information detected by the directional antenna 51 of the detection device 5 and related to the persons A to C who carry an ID card. As described above, in the present exemplary embodiment, whether a person is an authorized person is determined on the basis of ID information regarding the person stored in an ID card. The ID information refers to information used to authenticate a person and is an example of authentication information. The ID information includes information stored in an ID card and face information for authentication.

In the present exemplary embodiment, therefore, unauthorized person presence information includes information indicating that person information regarding the persons A to D who might view restricted electronic documents and authorized person information regarding the persons A to C, who are authorized to view the restricted electronic documents, do not match. The unauthorized person presence information is output to the operation unit 33 from the determination unit 31 in the control terminal 3 when at least part of ID information regarding persons who might view restricted electronic documents has not been obtained.

In the case of disagreement with authorized person information (in the former case), the unauthorized person presence information might be information indicating that the number of persons identified by the person information is larger than the number of authorized persons identified by the authorized person information or information indicating presence of unauthorized persons detected as a result of comparison between the person information and the authorized person information. That is, there are a case where the number of persons in a meeting and the number of authorized persons are compared (value comparison) and do not match and a case where whether each of persons in a meeting is an authorized person is determined (individual determination) and not all persons are authorized persons. In the case of the individual determination, the unauthorized person presence information might be information indicating that identification information for authentication included in the person information and identification information for authentication included in the authorized person information do not match or information indicating that face information for authentication included in the person information and face information for authentication included in the authorized person information do not match.

In the present exemplary embodiment, if the number of persons identified by the person information is four, namely the persons A to D, and the number of authorized persons identified by the authorized person information is three, namely the persons A to C, for example, the number of persons identified by the person information is larger than the number of authorized persons identified by the authorized person information since the person D is included in the person information but is not included in the authorized person information.

That is, if the number of persons in a meeting is four and the number of authorized persons is three, the number of persons in the meeting and the number of authorized persons do not match in comparison (value comparison). If whether each of the persons A to D in the meeting is an authorized person is determined, not all the persons are authorized persons since the person D is an unauthorized person.

If the person A is not authorized to view a certain restricted electronic document but the persons B and C are authorized to view the certain restricted electronic documents, for example, the person A has identification information for authentication included in the person information, but identification information for authentication regarding the person A is not included in the authorized person information. That is, the authorized person information does not include identification information for authentication regarding the person A, who has ID information. As a result, identification information for authentication included in the person information and identification information for authentication included in the authorized person information do not match, and face information for authentication included in the person information and face information for authentication included in the authorized person information do not match. In either case, the certain restricted electronic document is prevented from being displayed on the display device 1.

In the case of a failure in obtainment (in the latter case), there are a case where the number of persons identified by the person information, which is information regarding persons who might view restricted electronic documents, is larger than the number of persons authenticated by authentication information and a case where a failure in obtainment of authentication information has occurred.

In the present exemplary embodiment, the number of persons in a meeting, namely four, is larger than the number of persons authenticated by ID information, namely three. In addition, if results of detection performed by the detection device 4 are not obtained as a result of communication trouble, a malfunction of a device, or the like, whether unauthorized persons might view restricted electronic documents is not determined. In this case, the restricted electronic documents are prevented from being displayed.

Although not illustrated in the flowchart of FIG. 3, if the determination unit 31 does not obtain ID information regarding all persons, restricted electronic documents may be prevented from being displayed on the display device 1 without making a determination based on the authorized person information. If some persons do not carry an ID card and ID information corresponding to all persons is not obtained, if part or all of results of detection performed by the detection device 4 are not obtained as a result of a malfunction and the number of persons is not clear, or if part of all of results of detection performed by the detection device 5 are not obtained and ID information regarding persons is unknown, for example, restricted electronic documents are prevented from being displayed on the display device 1.

The flowchart of FIG. 3 will be referred to again.

If the restricted electronic documents are not displayed on the display device 1 (S108), a process for giving authority is performed. That is, the operation unit 33 identifies a position of a person (unauthorized person) who is not authorized to view the restricted electronic documents that are not displayed on the display device 1 or a position of a person who does not carry an ID card (a person without an ID) on the basis of a result of the determination made by the determination unit 31 (S109).

As illustrated in FIG. 4A, the operation unit 33 displays an image of the identified person on the display device 1 (S110). In the present exemplary embodiment, a face image 11 of the person D, who does not carry an ID card, is displayed on the display device 1. As a result, a target of the process for giving authority, which is necessary to display the restricted electronic documents, is identified.

In an example illustrated in FIG. 4A, a message 12, “Do you give authority to this person?”, is displayed, and there are options “YES” and “NO”. “YES” or “NO” may be selected through the reception unit 32 of the control terminal 3. If “YES” is selected, the process ends, and the restricted electronic documents are displayed on the display device 1. If “NO” is selected, the restricted electronic documents are not displayed on the display device 1.

In a modification, as illustrated in FIG. 4B, a message 13, “Persons A, B, and C are authorized”, is displayed on the display device 1. A face image of the person D is also displayed, and the persons A to C, who are authorized and can give authority, are indicated. The persons A to C is thus asked whether to perform the process for giving authority, and a smooth process is expected to be performed.

In other words, even one of the persons A to C, who carry an ID card, might not be authorized to view a restricted electronic document. In this case, a face image of the one of the persons A to C is displayed on the display device 1 along with the face image of the person D as an unauthorized person.

The control terminal 3 performs the process for giving authority. The control terminal 3 performs the process for giving authority when a person who desires to give authority approaches the control terminal 3 and, in the present exemplary embodiment, holds an ID card thereof onto the reception unit 32 of the control terminal 3.

A case where the person C, who is an authorized person, gives authority to the person D will be described. Since the intensity of radio waves measured by the directional antenna 51 of the detection device 5 increases when the person C, who carries an ID card, approaches the control terminal 3, the intensity of radio waves is measured (S111), and the movement of the person C is monitored.

The reception unit 32 identifies a person among the persons A to C whose is trying to give authority by detecting an ID card who intensity of radio waves increases. After the person who is trying to give authority is identified, the reception unit 32 of the control terminal 3 may cause the display device 1 to indicate the person.

The process for giving authority includes approval by an authorized person and a request by an unauthorized person (a person to which authority is to be given). This will be specifically described hereinafter.

After the reception unit 32 detects an increase in the intensity of radio waves from the ID card carried by the person C and approval by the person C, that is, holding of the ID card carried by the person C onto the reception unit 32 (S112), the approval by the authorized person is completed.

Next, the position of the unauthorized person or the person without an ID, namely the person D, is identified from information transmitted from the detection device 4 or the detection device 5 (S113), and reception of a request from the person D is performed. That is, a request issued by the person D who has approached the control terminal 3 is detected (S114). The person D determines whether to request authority using the reception unit 32 of the control terminal 3. Because the person D has to make a nondisclosure agreement to be authorized, the person D needs to issue a request.

If receiving a request issued by the person D, the reception unit 32 instructs the storage device 2 to record the approval and the request and store the record in a server (S115). More specifically, the reception unit 32 of the control terminal 3 associates the ID information regarding the person C, who has given the approval, the face image of the person D, who has issued the request, a timestamp of the process for giving authority, a timestamp of the request, and document IDs of the restricted electronic documents with one another and transmits these pieces of information to the storage device 2. The storage device 2 stores the information transmitted from the reception unit 32. The process for giving authority performed by the persons C and D is thus completed.

Since there is no ID information regarding the person D, who does not carry an ID card, information that can be used to identify a person, such as a face image, a name of the person, and a name of a company, is stored in the storage device 2 for the person D.

A record of the process for giving authority is thus stored to make it possible to later examine the process and trace the information obtained during the process.

The reception unit 32 then instructs the storage device 2 to display the restricted electronic documents on the display device 1. The restricted electronic documents, which have not been displayed on the display device 1, are displayed on the display device 1 (S116).

In the present exemplary embodiment, if the unauthorized person presence information, which indicates that authorized persons might view restricted electronic documents, is obtained when the restricted electronic documents are displayed on the display device 1, the operation unit 33 of the control terminal 3 prevents the restricted electronic documents from being displayed on the display device 1. As a result, the value of the restriction upon access to electronic documents is not diminished.

Although a configuration when there are persons who carry an ID card and a person who does not carry an ID card has been described in the present exemplary embodiment, another configuration may be employed, instead, when all persons carry an ID card. For example, a gate, which is not illustrated, including a reader capable of reading ID cards and a camera capable of capturing face images may be provided at an entrance of a meeting room, and ID information and face images may be associated with each other when persons pass through the gate, in order to omit the detection device 4. When ID information and face images are associated with each other in advance, the camera may be omitted.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electronic document display control system comprising:
an obtaining unit that, when a restricted electronic document, which is available only to authorized persons when displayed, is displayed on a display device, obtains unauthorized person presence information, which indicates that an unauthorized person might view the restricted electronic document; and
a display control unit that, when the obtaining unit obtains the unauthorized person presence information, prevents the restricted electronic document from being displayed.

2. The electronic document display control system according to claim 1,
wherein the unauthorized person presence information includes information indicating that person information, which is information regarding persons who might view the restricted electronic document, and authorized person information, which is information regarding authorized persons, do not match.

3. The electronic document display control system according to claim 2,
wherein the unauthorized person presence information is information indicating that a number of persons identified by the person information is larger than a number of authorized persons identified by the authorized person information.

4. The electronic document display control system according to claim 2,
wherein the unauthorized person presence information is information indicating presence of the unauthorized person identified as a result of comparison between the person information and the authorized person information.

5. The electronic document display control system according to claim 4,
wherein the unauthorized person presence information is information indicating that identification information for authentication included in the person information and identification information for authentication included in the authorized person information do not match.

6. The electronic document display control system according to claim 4,
wherein the unauthorized person presence information is information indicating that face information for authentication included in the person information and face information for authentication included in the authorized person information do not match.

7. The electronic document display control system according to claim 1,
wherein the unauthorized person presence information is output to the obtaining unit when at least part of authentication information regarding persons who might view the restricted electronic documents has not been obtained.

8. The electronic document display control system according to claim 7,
wherein the unauthorized person presence information is information indicating that a number of persons identified by person information, which is information regarding persons who might view the restricted electronic document, is larger than a number of persons authenticated by the authentication information.

9. The electronic document display control system according to claim 7,
wherein, if a failure in obtainment of the authentication information occurs when the restricted electronic document is displayed on the display device, the display control unit prevents the restricted electronic document from being displayed.

10. The electronic document display control system according to claim 1,
wherein, if one of the authorized persons gives authority to the unauthorized person, the display control unit allows the restricted electronic document to be displayed on the display device.

11. The electronic document display control system according to claim 10,
wherein the display control unit displays, on the display device, a face image of the unauthorized person to which the authority is to be given to display the restricted electronic document.

12. An electronic document display control system comprising:
an obtaining unit that, when a restricted electronic document, which is available only to authorized persons when displayed, is displayed on a display device, obtains information indicating that a person who has identification information for authentication but is not authorized to view the restricted electronic document or a person who does not have the identification information for authentication might view the restricted electronic document; and
a display control unit that, if the obtaining unit obtains the information, prevents the restricted electronic document from being displayed.

13. An electronic document display control system comprising:
obtaining means for, when a restricted electronic document, which is available only to authorized persons when displayed, is displayed on a display device, obtaining unauthorized person presence information, which indicates that an unauthorized person might view the restricted electronic document; and
display control means for, when the obtaining means obtains the unauthorized person presence information, prevents the restricted electronic document from being displayed.
